(19) United States
(12) Patent Application Publication
(10) Pub. No.: US 2026/0333308 A1
(43) Pub. Date: Oct. 22, 2026

(54) SYNCHRONIZATION SIGNAL TRANSMISSION METHOD AND APPARATUS, DEVICE, AND STORAGE MEDIUM

(71) Applicant: VIVO MOBILE COMMUNICATION CO., LTD., Dongguan (CN)

(72) Inventors: Dongru LI, Dongguan (CN); Kai WU, Dongguan (CN)

(21) Appl. No.: 19/708,974

(22) Filed: Jun. 16, 2026

Related U.S. Application Data
(63) Continuation of application No. PCT/CN2024/139708, filed on Dec. 16, 2024.

(30) Foreign Application Priority Data
Dec. 19, 2023 (CN) 202311764253.1

(51) Int. Cl. H04W 72/044; H04W 56/00

(52) U.S. Cl. CPC H04W 72/044; H04W 56/0015

(57) ABSTRACT

A synchronization signal transmission method and a device are provided. The synchronization signal transmission method includes: A first device detects a first synchronization signal. The first synchronization signal includes a first synchronization sequence, a second synchronization sequence, and a payload. The first device performs at least one of time-frequency domain synchronization, cell search, cell selection, channel measurement, or cell broadcast based on the first synchronization signal.

### CROSS-REFERENCE TO RELATED APPLICATIONS

This application is a continuation of International Patent Application No. PCT/CN2024/139708, filed on Dec. 16, 2024, which claims priority to Chinese Patent Application No. 202311764253.1, filed with the China National Intellectual Property Administration on Dec. 19, 2023 and entitled “SYNCHRONIZATION SIGNAL TRANSMISSION METHOD AND APPARATUS, DEVICE, AND STORAGE MEDIUM”, both of which are incorporated herein by reference in their entireties.

### TECHNICAL FIELD

This application relates to the communication field, and more specifically, to a synchronization signal transmission method and apparatus, a device, and a storage medium.

### BACKGROUND

When a terminal performs operations such as cell search based on a synchronization signal block (Synchronization Signal Block, SSB) structure in new radio (New Radio, NR), data buffer and demodulation need to be performed. In addition, a larger volume of buffered data indicates larger power consumption and complexity of the terminal.

### SUMMARY

Embodiments of this application provide a synchronization signal transmission method and apparatus, a device, and a storage medium.

According to a first aspect, a synchronization signal transmission method is provided, which is performed by a first device. The method includes:

A first device detects a first synchronization signal.

The first synchronization signal includes a first synchronization sequence, a second synchronization sequence, and a payload.

The first device performs at least one of time-frequency domain synchronization, cell search, cell selection, channel measurement, or cell broadcast based on the first synchronization signal.

According to a second aspect, a synchronization signal transmission method is provided, which is performed by a second device. The method includes:

A second device sends a first synchronization signal to a first device.

The first synchronization signal includes a first synchronization sequence, a second synchronization sequence, and a payload, where the first synchronization signal is used for at least one of time-frequency domain synchronization, cell search, cell selection, channel measurement, or cell broadcast.

According to a third aspect, a synchronization signal transmission apparatus is provided, including:
a detection unit, configured to detect a first synchronization signal, where
the first synchronization signal includes a first synchronization sequence, a second synchronization sequence, and a payload; and
a processing unit, configured to perform at least one of time-frequency domain synchronization, cell search, cell selection, channel measurement, or cell broadcast based on the first synchronization signal.

According to a fourth aspect, a synchronization signal transmission apparatus is provided, including:
a sending unit, configured to send a first synchronization signal to a first device.

The first synchronization signal includes a first synchronization sequence, a second synchronization sequence, and a payload, where the first synchronization signal is used for at least one of time-frequency domain synchronization, cell search, cell selection, channel measurement, or cell broadcast.

According to a fifth aspect, a first device is provided. The first device includes a processor and a memory. The memory stores a program or an instruction runnable on the processor. The program or the instruction, when executed by the processor, implements the steps of the method described in the first aspect.

According to a sixth aspect, a first device is provided, including a processor and a communication interface. The communication interface is configured to detect a first synchronization signal.

The first synchronization signal includes a first synchronization sequence, a second synchronization sequence, and a payload.

The processor is configured to perform at least one of time-frequency domain synchronization, cell search, cell selection, channel measurement, or cell broadcast based on the first synchronization signal.

According to a seventh aspect, a second device is provided. The second device includes a processor and a memory. The memory stores a program or an instruction runnable on the processor. The program or the instruction, when executed by the processor, implements the steps of the method described in the second aspect.

According to an eighth aspect, a second device is provided, including a processor and a communication interface. The communication interface is configured to send a first synchronization signal to a first device.

The first synchronization signal includes a first synchronization sequence, a second synchronization sequence, and a payload, where the first synchronization signal is used for at least one of time-frequency domain synchronization, cell search, cell selection, channel measurement, or cell broadcast.

According to a ninth aspect, a readable storage medium is provided. The readable storage medium stores a program or an instruction. The program or the instruction, when executed by a processor, implements the steps of the method described in the first aspect, or implements the steps of the method in the second aspect.

According to a tenth aspect, a wireless communication system is provided, including a first device and a second device. The first device may be configured to perform the steps of the method in the first aspect, and the second device may be configured to perform the steps of the method described in the second aspect.

According to an eleventh aspect, a chip is provided. The chip includes a processor and a communication interface. The communication interface is coupled to the processor. The processor is configured to run a program or an instruction to implement the method described in the first aspect or implement the method described in the second aspect.

According to a twelfth aspect, a computer program/program product is provided. The computer program/program product is stored in a storage medium. The program/program product is executed by at least one processor to implement the steps of the method described in the first aspect or implement the steps of the method described in the second aspect.

In embodiments of this application, the first device detects the first synchronization signal. The first synchronization signal includes the first synchronization sequence, the second synchronization sequence, and the payload. The first device performs at least one of time-frequency domain synchronization, cell search, cell selection, channel measurement, or cell broadcast based on the first synchronization signal.

### BRIEF DESCRIPTION OF THE DRAWINGS

In order to describe the technical solutions of embodiments of this application more clearly, drawings required for describing embodiments of this application are briefly described below. Apparently, the drawings in the following description show only some embodiments of this application, and a person of ordinary skill in the art may derive other drawings from these drawings without creative efforts.

FIG. 1 is a block diagram of a wireless communication system to which an embodiment of this application may be applied;

FIG. 2 shows an example of a structure of an SSB according to an embodiment of this application;

FIG. 3 shows an example of an OOK waveform according to an embodiment of this application;

FIG. 4 shows an example of an OOK-1 waveform according to an embodiment of this application;

FIG. 5 shows an example of an OOK-4 waveform according to an embodiment of this application;

FIG. 6 is a schematic flowchart of a synchronization signal transmission method according to an embodiment of this application;

FIG. 7 is a schematic diagram of an operating principle of an NR LP WUR/WUS according to an embodiment of this application;

FIG. 8 shows an example of a structure of a first synchronization signal according to an embodiment of this application;

FIG. 9 shows another example of a structure of a first synchronization signal according to an embodiment of this application;

FIG. 10 shows another example of a structure of a first synchronization signal according to an embodiment of this application;

FIG. 11 is a schematic block diagram of a synchronization signal transmission apparatus according to an embodiment of this application;

FIG. 12 is a schematic block diagram of another synchronization signal transmission apparatus according to an embodiment of this application;

FIG. 13 shows an example of a communication device according to an embodiment of this application;

FIG. 14 is a schematic diagram of a hardware structure of a terminal for implementing an embodiment of this application; and

FIG. 15 shows an example of a network side device according to an embodiment of this application.

### DETAILED DESCRIPTION

Technical solutions in embodiments of this application are clearly described below with reference to drawings in embodiments of this application. Apparently, the described embodiments are merely some rather than all embodiments of this application. All other embodiments obtained by a person of ordinary skill in the art based on embodiments of this application fall within the protection scope of this application.

The terms “first”, “second”, and the like in this application are used for distinguishing between similar objects, rather than describing a specific sequence or order. It should be understood that the terms used in this way may be transposed where appropriate, so that embodiments of this application can be implemented in a sequence other than those illustrated or described herein. In addition, objects defined by “first” and “second” are generally of the same class with a quantity of objects unlimited. For example, one or more first objects may be arranged. In addition, the term “or” in this application denotes at least one of the connected objects. For example, “A or B” includes three solutions, namely, solution 1: including A but excluding B; solution 2: including B but excluding A; or solution 3: including both A and B. The character “/” generally indicates that associated objects are in an “or” relationship.

In this application, the term “indication” may be a direct indication (or referred to as an explicit indication) or an indirect indication (or referred to as an implicit indication). The direct indication may be understood as that a sending party explicitly notifies a receiving party of content such as specific information, an operation that needs to be performed, or a request result in the indication that is sent. The indirect indication may be understood as that a receiving party determines corresponding information based on an indication sent by a sending party, or performs determining and determines an operation that needs to be performed or a request result based on a determining result.

It should be noted that the technology described in embodiments of this application may be applied to a long term evolution (Long Term Evolution, LTE)/LTE-advanced (LTE-Advanced, LTE-A) system, and may be further applied to another wireless communication system, such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency-division multiple access (Single-carrier Frequency-Division Multiple Access, SC-FDMA) system, or another system. The terms “system” and “network” in embodiments of this application are usually used interchangeably, and the described technology may be applied to the systems and radio technologies mentioned above, and may be further applied to other systems and radio technologies. A new radio (New Radio, NR) system is described below for an illustrative purpose, and the term NR is used in most of the following descriptions, but the technologies may also be applied to systems other than the NR system, such as a 6^{th} Generation (6th Generation, 6G) communication system.

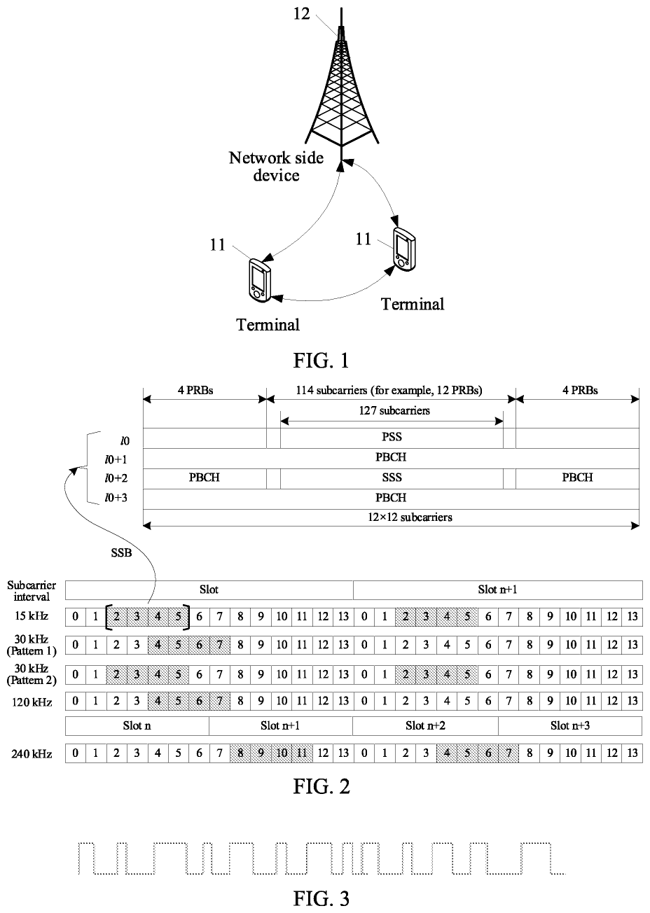

FIG. 1 is a block diagram of a wireless communication system to which an embodiment of this application may be applied.

As shown in FIG. 1, the wireless communication system includes a terminal 11 and a network side device 12.

The terminal 11 may be a terminal side device such as a mobile phone, a tablet computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile Internet device (Mobile Internet Device, MID), an augmented reality (Augmented Reality, AR)/virtual reality (Virtual Reality, VR) device, a robot, a wearable device (Wearable Device), an aircraft (flight vehicle), a vehicle-mounted device (Vehicle User Equipment, VUE), a ship-borne device, a pedestrian terminal (Pedestrian User Equipment, PUE), a smart home appliance (a home device having a wireless communication function, such as a refrigerator, a television, a washing machine, or furniture), a game console, a personal computer (Personal Computer, PC), a teller machine, or a self-service machine. The wearable device includes a smart watch, a smart band, a smart earphone, smart glasses, smart jewelry (a smart bracelet, a smart chain, a smart ring, a smart necklace, a smart anklet, a smart ankle chain, or the like), a smart wristband, smart clothing, or the like. The vehicle-mounted device may also be referred to as a vehicle-mounted terminal, a vehicle-mounted controller, a vehicle-mounted module, a vehicle-mounted component, a vehicle-mounted chip, a vehicle-mounted unit, or the like. It should be noted that, a specific type of the terminal 11 is not limited in embodiments of this application.

The network side device 12 may include an access network device.

The access network device may also be referred to as a radio access network (Radio Access Network, RAN) device, a radio access network function, or a radio access network unit. The access network device may include a base station, a wireless local area network (Wireless Local Area Network, WLAN) access point (Access Point, AP), a wireless fidelity (Wireless Fidelity, Wi-Fi) node, or the like. The base station may be referred to as a NodeB (Node B, NB), an evolved NodeB (Evolved Node B, eNB), a next generation NodeB (the next generation Node B, gNB), a new radio NodeB (New Radio Node B, NR Node B), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home Node B, HNB), a home evolved NodeB (home evolved Node B), a transmission reception point (Transmission Reception Point, TRP), or another appropriate term in the art. The base station is not limited to a specific technical term, provided that the same technical effects are achieved. It should be noted that, in embodiments of this application, only a base station in the NR system is used as an example, and a specific type of the base station is not limited.

To better understand embodiments of this application, technologies related to this application are described.
1. Classification and features of ambient Internet of Things (Ambient Internet of Things, Ambient IoT, A-IoT) devices.

In the 3GPP R19 A-IoT study, an ambient Internet of Things device is characterized based on its energy storage capacity and its ability to generate radio frequency signals for transmission. The A-IoT device has one of the following energy storage capabilities:

Storage capacity 1: The device has no capability of storing energy, or has a capability of storing energy.

Storage capacity 2: The device can store energy up to E1 or E2 joules, where E1 may be equal to E2.

Storage capacity 3: The device can store energy up to E2 joules.

Based on these storage capacities, this study considers the following types of ambient Internet of Things devices:

Type A: Devices configured with or not configured with energy storage and configured with independent signal generation/amplification, namely, backscatter transmission devices.

Type B: Devices configured with energy storage but not configured with independent signal generation, namely, backscatter transmission devices, where stored energy may be used for amplifying reflected signals.

Type C: Devices configured with energy storage and independent signal generation, namely, devices including active radio frequency components for transmission.
2. A-IoT data/service type

3GPP R19 A-IoT studied the following data/service types:
device-originated (Device-originated, DO) data; and
device-terminated (Device-terminated, DT) data.

DO traffic (traffic) includes DO autonomous (DO autonomous, DO-A) and DO DT triggered (DO device-terminated triggered, DO-DTT).

DO data and DT data represent data flows originating from an A-IoT device (similar to a radio frequency identification (radio frequency identification devices, RFID) tag) or transmitted to an A-IoT device. For data flows originating from an A-IoT device, i.e., DO data, it may be further classified into the following:

DO-A: It means that an A-IoT device autonomously initiates data transmission.

For example, the A-IoT device is connected to a large quantity of sensors of various types, and the sensors collect and actively report, when necessary, information about an environment, a device, and a living creature.

DO-DTT: It means that a reader device such as a base station triggers an A-IoT device to initiate data transmission.

For example, asset identification, status reporting, and tracking are all downlink (Downlink, DL)-triggered reporting. A reader device collects data from a tag by triggering an inventory program. Because data is generated/initiated in the tag (tag), the service should be considered as a DO service initiated by the tag in response to a control command from the reader device.
3. A-IoT deployment or operation scenario

A-IoT deployment or operation scenarios may be divided into the following three types:

Scenario 1: A-IoT is deployed in a new radio (New Radio, NR) system bandwidth, which is also referred to as in-band deployment (In-band deployment). In this scenario, in an implementation, a same base station provides services for an A-IoT device and an NR user equipment (User Equipment, UE). In another implementation, different base stations provide services for an A-IoT device and an NR UE.

Scenario 2: A-IoT is deployed in a guard interval of an NR system bandwidth, which is also referred to as guard band deployment (guard band deployment). In this scenario, in an implementation, a same base station provides services for an A-IoT device and an NR UE. In another implementation, different base stations provide services for an A-IoT device and an NR UE.

Scenario 3: A-IoT is deployed outside an NR system bandwidth, which is also referred to as stand-alone deployment (stand-alone deployment). In this scenario, generally, a base station provides services for only A-IoT devices.
4. SSB

A wireless device (a terminal) performs a cell search process to achieve time-frequency domain synchronization with a base station by using synchronization signals and broadcast signals/channels provided by a cell of the base station, and obtains frequency domain and time domain locations of a time-frequency resource of the cell deployed by the base station, as well as a physical cell identity (ID).

FIG. 2 shows an example of a structure of an SSB according to an embodiment of this application.

As shown in FIG. 2, a terminal first detects an NR primary synchronization signal (Primary Synchronization Signal, PSS), to obtain a part of a physical cell identity (ID), that is, N(2)_ID, and to achieve orthogonal frequency division multiplexing (Orthogonal Frequency Division Multiplexing, OFDM) symbol timing and frequency synchronization, and then detects a secondary synchronization signal (Secondary Synchronization Signal, SSS), to obtain another part of the physical cell ID, that is, N(1)_ID, so as to obtain a complete physical cell ID, that is, physical cell identity (Physical Cell Identity, PCI). In other words,

$$PCI = {N}_{ID}^{cell} = 3 {N}_{ID}^{( 1 )} + {N}_{ID}^{( 2 )} .$$

Next, the terminal detects a physical broadcast channel (Physical Broadcast Channel, PBCH) and a reference signal, i.e., demodulation reference signal (Demodulation Reference Signal, DMRS), for demodulating the PBCH, to obtain a system frame number (system frame number) and an SSB index, and further achieve radio frame (subframe) timing.
5. Low power signal waveform

A low power signal is usually sent by using a simple waveform, for example, on-off keying (On-Off Keying, OOK) or frequency-shift keying (Frequency-shift keying, FSK). In this way, a terminal can identify a low power signal through simple energy detection, frequency detection, or the like.

OOK-1 and OOK-4 are two potential low power signal waveforms. The waveforms OOK-1 and OOK-4 may be a waveform shown in FIG. 3. These two waveforms are amplitude-modulated, and therefore all subcarriers are uniformly modulated. In other words, frequency domain resources are not utilized.

For multiple-carrier amplitude shift keying (Multiple-Carrier Amplitude Shift Keying, MC-ASK) waveform generation, K is a size of inverse fast Fourier transform (Inverse Fast Fourier Transform, iFFT) of cyclic prefix-orthogonal frequency division multiple access (Cyclic Prefix-Orthogonal Frequency Division Multiple Access, CP-OFDMA), and N is a number of single carriers (Single Carrier, SC) used by LP-WUS, including potential guard bands (For MC-ASK waveform generation, where K is size of IFFT of CP-OFDMA, N is number of SCs used by LP-WUS including potential guard-bands). Further,

Option OOK-1: One OFDM symbol carries a single piece of OOK-bit information.
“1” indicates that all SCs are modulated (OOK=1 means all SCs are modulated).
“0” indicates that all SCs are at a zero power (from a baseband perspective) (OOK=0 means all SCs are zero power (from base-band point of view)).

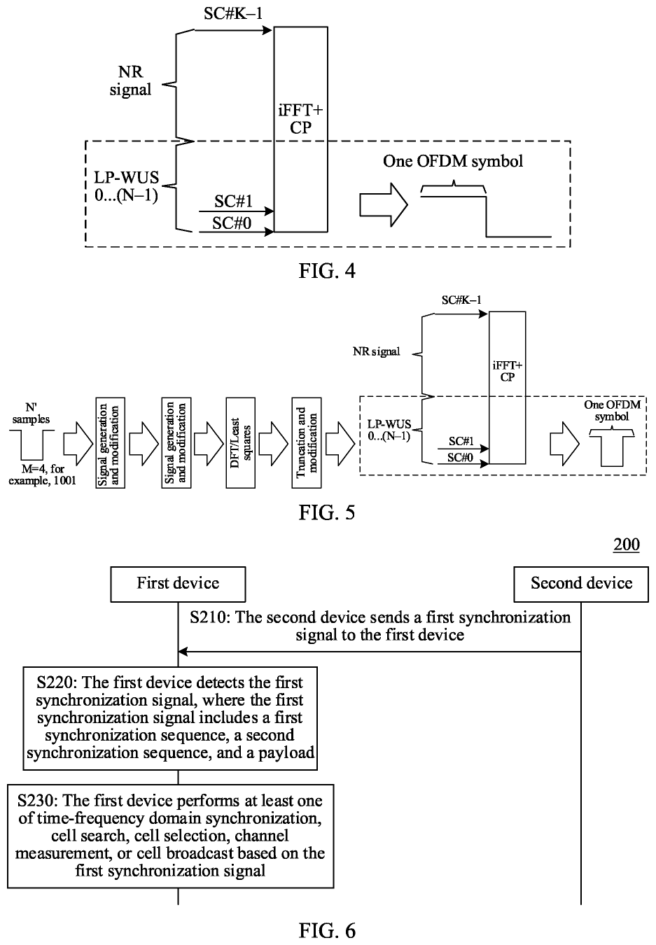

FIG. 4 shows an example of an OOK-1 waveform according to an embodiment of this application.

As shown in FIG. 4, an OOK-1 waveform of a low power signal is characterized by including one OOK bit within a length of one OFDM symbol.

OOK-4: One OFDM symbol carries M OOK bits.

FIG. 5 shows an example of an OOK-4 waveform according to an embodiment of this application.

As shown in FIG. 5, an OOK-4 waveform of a low power signal is characterized by including M OOK bits or OOK chips within a length of one OFDM symbol.

In fact, it may be understood that a difference between OOK-1 and OOK-4 lies in a quantity of OOK bits that can be carried within one OFDM symbol.

It should be noted that, one bit of “0” or “1” may be understood as one chip.

It should be noted that when the SSB structure in the terminal NR performs synchronization-related operations, the terminal needs to continuously receive signals and buffer the received signals, and then perform sliding-related detection to demodulate the SSB. This has a high requirement on power consumption and complexity of the terminal. However, requirements of the SSB structure in the NR on a terminal detection capability and demodulation complexity are not applicable to a low power and low detection complexity-oriented communication device (for example, an A-IoT device or a low power device). In view of this, embodiments of this application provide a synchronization signal transmission method, which can reduce power consumption and complexity in synchronization signal detection.

The synchronization signal transmission method provided in embodiments of this application is described below in detail through some embodiments and application scenarios thereof with reference to the drawings.

FIG. 6 is a schematic flowchart of a synchronization signal transmission method 200 according to an embodiment of this application.

The method 200 is interactively performed by a first device and a second device. The first device may be a terminal device, for example, an ambient Internet of Things (Ambient Internet of Things, Ambient IoT, A-IoT) device or a low power device, and is adapted to be deployed in a 3GPP system. In some embodiments, the A-IoT device is an ultra-low complexity and ultra-low power terminal. The second device may be a network side device or a terminal device.

As shown in FIG. 6, the synchronization signal transmission method 200 may include at least part of the following content:
S210: The second device sends a first synchronization signal to the first device.
S220: The first device detects the first synchronization signal.

The first synchronization signal includes a first synchronization sequence, a second synchronization sequence, and a payload.
S230: The first device performs at least one of time-frequency domain synchronization, cell search, cell selection, channel measurement, or cell broadcast based on the first synchronization signal.

It should be noted that, the first synchronization signal includes a first synchronization sequence, a second synchronization sequence, and a payload, and the first synchronization signal is used for at least one of time-frequency domain synchronization, cell search, cell selection, channel measurement, or cell broadcast. In some embodiments, the above may be understood as that the first synchronization sequence, the second synchronization sequence, and the payload are used for at least one of time-frequency domain synchronization, cell search, cell selection, channel measurement, or cell broadcast. A specific function to which each of the three is used is not specifically defined herein. In addition, the first synchronization signal includes a first synchronization sequence, a second synchronization sequence, and a payload, and therefore the first synchronization signal is not limited to only one synchronization signal type. For example, the first synchronization sequence may be an LP-SS, and the second synchronization sequence may be a PSS and an SSS. In this case, the LP-SS, the PSS, and the SSS all belong to the first synchronization signal.

Optionally, the step in which the first device detects the first synchronization signal includes: the first device first detects the first synchronization sequence or the first synchronization sequence and a payload of the first synchronization sequence, and then detects the second synchronization sequence or the second synchronization sequence and a payload of the second synchronization sequence.

For example, the first synchronization sequence is an OOK-1 sequence, and the second synchronization sequence is an OOK-4 sequence, an OFDM sequence, or an OOK-overlaid OFDM sequence (which may be understood as a hybrid sequence of OOK and OFDM sequences).

Optionally, the step in which the first device detects the first synchronization signal includes: the first device skips detecting the first synchronization sequence or the first synchronization sequence and a payload of the first synchronization sequence, but directly detects the second synchronization sequence or the second synchronization sequence and a payload of the second synchronization sequence.

In other words, in some embodiments, that the terminal detects the first synchronization signal includes that the terminal detects a part of the first synchronization signal. For example, the first device skips detecting the first synchronization sequence but detects only the second synchronization sequence.

In an embodiment, whether the terminal or the first device detects the first synchronization sequence depends on at least one of the following:
1) Whether detection of the first synchronization sequence is supported.
2) Whether the second synchronization sequence can be directly obtained by demodulation without detecting the first synchronization sequence is supported.
3) Network side device configuration or protocol agreement.

If the terminal does not support detection of the first synchronization sequence, the terminal skips detecting the first synchronization sequence. Similarly, if the terminal can directly correctly demodulate and detect the second synchronization sequence, the terminal may skip detecting the first synchronization sequence.

The first device may detect and demodulate the first synchronization sequence to assist in subsequent demodulation of the second synchronization sequence and the payload, thereby reducing synchronization complexity for the first device, and reducing power consumption and complexity in synchronization signal detection.

It should be understood that at least one of the first synchronization sequence, the second synchronization sequence, or the payload may be repeatedly transmitted. This is not specifically limited in this application. For example, within a period of the first synchronization sequence, at least one of the second synchronization sequence or the payload may be repeatedly transmitted.

In some embodiments, the first synchronization signal satisfies at least one of the following:
transmission periods or update periods of at least two of the first synchronization sequence, the second synchronization sequence, and the payload are different;
the transmission periods or update periods of at least two of the first synchronization sequence, the second synchronization sequence, and the payload satisfy a multiple relationship;
offset values of at least two of the first synchronization sequence, the second synchronization sequence, and the payload are different;
reference locations of the offset value of the first synchronization sequence, the offset value of the second synchronization sequence, and the offset value of the payload are the same;
at least one of the offset value of the second synchronization sequence or the offset value of the payload is determined based on the first synchronization sequence;
at least two of the first synchronization sequence, the second synchronization sequence, and the payload have or do not have a transmission interval;
a chip rate of the first synchronization sequence is different from a chip rate of the second synchronization sequence;
a synchronization precision of the first synchronization sequence is less than a synchronization precision of the second synchronization sequence;
a transmission resource quantity of the first synchronization sequence is different from at least one of a transmission resource quantity of the second synchronization sequence or a transmission resource quantity of the payload;
a waveform of the first synchronization sequence is different from a waveform of the second synchronization sequence;
a receiver for receiving the first synchronization sequence is different from a receiver for receiving the second synchronization sequence; or
at least one of the first synchronization sequence or the second synchronization sequence is a low power synchronization sequence.

For example, the offset value of at least one of the first synchronization sequence, the second synchronization sequence, or the payload may be an offset value relative to a particular time. For example, the offset value of at least one of the first synchronization sequence, the second synchronization sequence, or the payload may be an offset value relative to a start time of an SFN0.

For example, at least one of the first synchronization sequence, the second synchronization sequence, or the payload may be repeatedly transmitted. In addition, an interval between adjacent repeated transmission operations is specified by a protocol or configured by a network.

For example, at least one of the transmission resource quantity of the first synchronization sequence, the transmission resource quantity of the second synchronization sequence, or the transmission resource quantity of the payload is different, which may include: at least one of a transmission occasion quantity of the first synchronization sequence, a transmission occasion quantity of the second synchronization sequence, or a transmission occasion quantity of the payload is different.

The transmission resource quantity may be understood as a quantity of transmission occasions.

For example, that a chip rate of the first synchronization sequence is different from a chip rate of the second synchronization sequence includes: the chip rate of the first synchronization sequence is less than the chip rate of the second synchronization sequence.

For example, the first synchronization sequence is used for reducing a detection range of the second synchronization sequence, thereby reducing power consumption and complexity in synchronization signal detection.

This reduces complexity in detecting the first synchronization sequence, but at the cost of lower synchronization precision obtained through the first synchronization sequence.

For example, the low power synchronization sequence belongs to a low power synchronization signal.

### Low Power Receiver

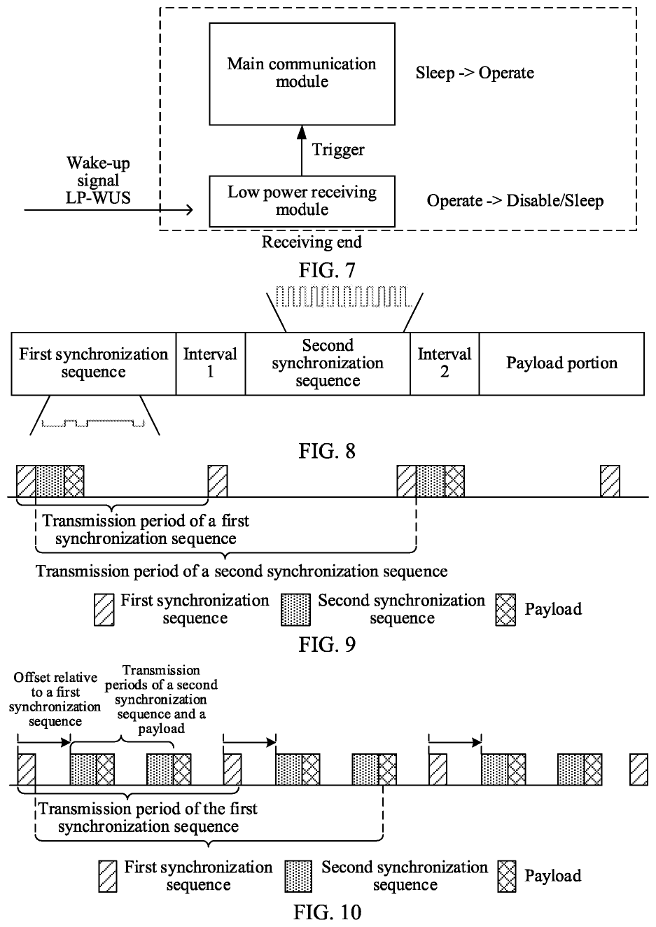

It is also referred to as a low power wake-up receiver (low power wake up radio, LP-WUR) or a near-zero power wake-up receiver (almost zero power wake up radio, AZP-WUR). A basic operating principle of the LP-WUR is as follows: A receiving end includes a first module and a second module. Specifically, as shown in FIG. 7, the first module is a main communication module, which is configured to send and receive mobile communication data, and the second module is a low power receiving module (also referred to as a low power wake-up receiving module), which is configured to receive a wake-up signal. A terminal in an energy saving state enables the low power receiving module to monitor the LP-WUS and disables the main communication module. When downlink data arrives, a network sends a wake-up signal to the terminal. After detecting the wake-up signal through the low power receiving module, the terminal triggers, through a series of determining operations, the main communication module to switch from disabled to enabled. In this case, the low power receiving module enters a disabled state from an operating state. The low power wake-up receiving module may be continuously enabled or intermittently enabled. When enabled, the low power wake-up receiving module may receive a low power wake-up signal.

A basic operating principle of the LP WUR is presented as follows after an LP WUR/wake-up signal (wake-up signal, WUS) is introduced into a mobile cellular system: A receiving end includes a first module and a second module. The first module is a main communication module, which is configured to receive communication data transmitted by a sending end and send communication data. The second module is a low power module, which is configured to receive a low power wake-up signal (LP-WUS) and a low power synchronization signal (LP-SS) that are sent by the sending end. The LP-WUS is used for waking up the main communication module in the receiving end. The LP-SS is used for providing time reference information and other information for receiving the low power consumption wake-up signal. For example, the LP-SS is used for performing radio resource management (RRM) measurement on a serving cell, and may further provide wake-up link management, for example, determine, based on a measurement result, whether to activate/deactivate an LP-WUR and disable a main radio (Main Radio, MR), that is, the main communication module. As shown in FIG. 7, A terminal in an energy saving state enables the low power receiving module to monitor the LP-WUS and disables the main communication module. When downlink data arrives, a network sends a wake-up signal to wake up the terminal. After detecting the wake-up signal through the low power receiving module, the terminal triggers, through a series of determining operations, the main communication module to switch from disabled to enabled. In this case, the low power receiving module enters a disabled state from an operating state. The low power wake-up receiving module may be continuously enabled or intermittently enabled. When enabled, the low power wake-up receiving module may receive a low power wake-up signal and a low power synchronization signal.

### Low Power Synchronization Signal (LP-SS)

An LP-SS is a periodically transmitted signal used for transmitting time information. A receiving end may obtain time synchronization information by receiving an LP-SS signal. In some embodiments, mobility measurement, channel measurement, or the like may be performed by receiving an LP-SS signal. An LP-SS and an LP-WUS are both received by a low power receiver. In an embodiment, the LP-SS may be considered as a downlink synchronization signal for LP-WUS reception. In another embodiment, the LP-SS signal may be used for terminal mobility measurement, such as cell selection, cell reselection, or cell handover. In addition, optionally, a specific association relationship may exist between an LP-SS signal sequence and an LP-WUS sequence. For example, the LP-SS signal sequence is a part of the LP-WUS sequence.

To save energy, in a radio resource control (Radio Resource Control, RRC) idle (idle)/inactive (inactive) state, the terminal may enable an LP-WUR to monitor an LP-WUS instead of the MR to monitor a paging occasion (Paging Occasion, PO), until an LP-WUS indicating wake-up is detected, at which point the MR resumes monitoring. When the terminal is monitoring the LP-WUS, the MR of the terminal may sleep.

However, to maintain RRM measurement, which cannot be relaxed for a serving cell, the MR of the terminal needs to wake up periodically to perform RRM measurement. As a result, even though LP-WUS monitoring replaces PO monitoring by the MR, energy saving of the terminal is still unsatisfactory due to the periodic RRM measurement performed by the MR. Therefore, in an LP-WUS study, LP-SS measurement by the LP-WUR may be leveraged to relax or replace measurement such as RRM, radio link monitor (Radio Link Monitor, RLM), and beam failure detection (Beam Failure Detection, BFD) by the MR. In this way, the terminal can achieve substantial power saving.

In this embodiment, the following technical effects can be achieved by designing the first synchronization signal to satisfy various requirements:
1. Transmission periods or update periods of at least two of the first synchronization sequence, the second synchronization sequence, and the payload are different, allowing more flexible configuration of a period of each part according to different requirements.
2. Offset values of at least two of the first synchronization sequence, the second synchronization sequence, and the payload are different, allowing more flexible configuration of a location relationship among all portions.
3. A chip rate of the first synchronization sequence is different from a chip rate of the second synchronization sequence, allowing diversification of a communication rate of the first synchronization signal.
4. A synchronization precision of the first synchronization sequence is less than a synchronization precision of the second synchronization sequence, allowing lower synchronization complexity for the first synchronization sequence. It should be noted that, in a case that the synchronization precision of the first synchronization sequence is less than the synchronization precision of the second synchronization sequence, the first synchronization sequence may also be referred to as a coarse synchronization sequence, and the second synchronization sequence may also be referred to as a fine synchronization sequence.
5. A transmission resource quantity of the first synchronization sequence is greater than at least one of a transmission resource quantity of the second synchronization sequence or a transmission resource quantity of the payload, to ensure detection efficiency of the first synchronization sequence. The transmission resource quantity may be understood as a quantity of transmission occasions.
6. A transmission resource quantity of the first synchronization sequence is less than at least one of a transmission resource quantity of the second synchronization sequence or a transmission resource quantity of the payload, to ensure detection efficiency of at least one of a transmission resource of the second synchronization sequence or a transmission resource of the payload. In addition, resource overheads of the first synchronization sequence can be reduced.

In some embodiments, the method 200 further includes:

The first device performs, based on the first synchronization sequence, at least one of frequency domain synchronization at a first precision or time synchronization at a second precision, where the first precision is at a granularity selected from at least one of a resource block (Resource Block, RB), a resource element (Resource Element, RE), an RB set, a synchronization raster (sync raster), or a synchronization raster set, and the second precision is at a granularity selected from at least one of a system frame, a half-frame, a subframe, a slot, or a symbol.

It may be understood that the frequency domain synchronization with the first precision means that the first synchronization sequence can only achieve frequency synchronization to the first precision. For example, the first precision is at a granularity of a synchronization raster, which means that the first synchronization sequence can only achieve synchronization to a synchronization raster size, and the first device may determine a synchronization raster index where the first synchronization sequence is located. However, RB and RE locations where the first synchronization sequence is located cannot be determined by the first device using only the first synchronization sequence. Similarly, time synchronization is understood in a comparable way, the only difference being the dimension.

For example, the first device slides in the frequency domain to identify a frequency range with a largest reference signal receiving power (Reference Signal Receiving Power, RSRP), so as to achieve the frequency domain synchronization with the first precision by using the first synchronization sequence.

In this embodiment, performing, by the first device based on the first synchronization sequence, at least one of the frequency domain synchronization at the first precision or the time synchronization at the second precision helps reduce a detection range of the second synchronization sequence.

In some embodiments, the first synchronization sequence includes at least one of the following characteristics:
the first synchronization sequence is a synchronization sequence applicable to at least one device type, where the at least one device type includes at least one of a type A, a type B, or a type C; or
in the first synchronization sequence, a duty cycle of a first level is greater than or equal to a duty cycle of a second level.

For example, the first level is a high level corresponding to a bit/chip of “1”, and the second level is a low level corresponding to a bit/chip of “0”.

For example, the type A, the type B, and the type C are defined as follows:

Type A: Devices configured with or not configured with energy storage and configured with independent signal generation/amplification, namely, backscatter transmission devices.

Type B: Devices configured with energy storage but not configured with independent signal generation, namely, backscatter transmission devices, where stored energy may be used for amplifying reflected signals.

Type C: Devices configured with energy storage and independent signal generation, namely, devices including active radio frequency components for transmission.

In this embodiment, the first synchronization sequence is a synchronization sequence applicable to at least one device type, where the at least one device type includes at least one of the type A, the type B, or the type C, which can ensure applicability and compatibility of the first synchronization sequence.

In this embodiment, the duty cycle of the first level in the first synchronization sequence is greater than or equal to the duty cycle of the second level, which can ensure that more energy is provided for the first device by using the first synchronization sequence, that is, more energy storage is provided for the first device.

In some embodiments, the method 200 further includes:

The first device performs, based on the second synchronization sequence, at least one of frequency domain synchronization at a third precision or time synchronization at a fourth precision, where the third precision is at a granularity selected from at least one of an RB, an RE, or a synchronization raster, and the fourth precision is at a granularity selected from at least one of a symbol or a chip.

It may be understood that, in an embodiment, the first device first detects the first synchronization sequence, which can help reduce a synchronization precision to a particular range, and then the first device detects the second synchronization sequence to further obtain a synchronization result with a higher precision.

In this embodiment, the first device performs, based on the first synchronization sequence, at least one of the frequency domain synchronization at the first precision or the time synchronization at the second precision, where the first precision is at the granularity selected from at least one of an RB, an RE, an RB set, a synchronization raster, or a synchronization raster set, and the second precision is at the granularity selected from at least one of a system frame, a half-frame, a subframe, a slot, or a symbol. In other words, after successfully detecting the first synchronization sequence, the first device can obtain at least one of coarse time domain synchronization or coarse frequency domain synchronization. Based on the above, the first device performs, based on the second synchronization sequence, at least one of the frequency domain synchronization at the third precision or the time synchronization at the fourth precision, where the third precision is at the granularity selected from at least one of an RB, an RE, or a synchronization raster, and the fourth precision is at the granularity selected from at least one of a symbol or a chip. In other words, the first device then detects the second synchronization sequence at a corresponding time-frequency location to achieve at least one of higher-precision time domain synchronization or higher-precision frequency domain synchronization.

Furthermore, since coarse synchronization has been obtained, the first device can buffer data within a small range around the second synchronization sequence and then detect the second synchronization sequence through coherent demodulation. In this way, not only a data buffer range can be reduced, for example, from a buffer length of 20 ms in NR to a buffer length of approximately one slot, but also reliability of sequence detection can be ensured.

In some embodiments, the second synchronization sequence carries partial information of cell identity information, and the payload carries information in the cell identity information other than the partial information of the cell identity information carried in the second synchronization sequence; or the payload carries the cell identity information; or the first synchronization sequence does not carry the cell identity information; or the first synchronization signal carries the cell identity information.

For example, the cell identity information may be a physical cell identity (Physical Cell Identity, PCI).

For example, the partial information may be a least significant bit (Least Significant Bit) or mod(cell ID, 3).

For example, the first synchronization sequence is the same across different cells. In other words, different cells may send the same first synchronization sequence.

In this embodiment, by designing the second synchronization sequence and the payload to carry the cell identity information, or by designing the first synchronization signal to carry the cell identity information, it can be ensured that the first device can obtain complete cell identity information. The first synchronization sequence does not carry cell identity information, meaning that the first synchronization sequence is shared among cells, which can reduce design complexity of the first synchronization sequence.

In some embodiments, the payload carries at least one of the following information: a main information block (Master Information Block, MIB), remaining system information (Remaining System Information, RMSI), a system frame number (System Frame number, SFN), or a half-frame indicator.

In this embodiment, the payload carries at least one of the following information: the MIB, the RMSI, the SFN, or the half-frame indicator, to ensure that the first device obtains a complete cell identity, that is, ensure that the first device can perform at least one of the time-frequency domain synchronization, the cell search, the cell selection, the channel measurement, or the cell broadcast based on the first synchronization signal. For example, the half-frame indicator may be used for half-frame synchronization.

In some embodiments, the payload satisfies at least one of the following:
the payload follows the first synchronization sequence;
the payload follows the second synchronization sequence; or
the payload includes a first portion and a second first portion, where the first portion follows the first synchronization sequence, and the second first portion follows the second synchronization sequence.

For example, if the payload follows the first synchronization sequence, it may be understood that the payload is a payload of the first synchronization sequence.

For example, if the payload follows the second synchronization sequence, it may be understood that the payload is a payload of the second synchronization sequence.

For example, the payload includes a first portion and a second first portion, where the first portion follows the first synchronization sequence, and the second first portion follows the second synchronization sequence. It may be understood that, the first synchronization signal includes two large blocks, where a first large block includes the first synchronization sequence and the first portion, and the second large block includes the second synchronization sequence and the second portion. A transmission interval exists or does not exist between the two large blocks, or transmission periods of the two large blocks are the same or different.

In some embodiments, at least one of the first synchronization sequence or the second synchronization sequence is an OOK waveform sequence or an OOK-overlaid (overlay) orthogonal frequency division multiplexing (Orthogonal Frequency Division Multiplexing, OFDM) waveform sequence. An OOK-overlaid OFDM waveform may be understood as a hybrid of OOK and OFDM waveforms. The OOK-overlaid OFDM waveform may be understood as an OOK high-level portion carrying an OFDM waveform.

In some embodiments, the first synchronization sequence is an OOK-1 waveform sequence, and the second synchronization sequence is an OOK-4 waveform sequence; or
the first synchronization sequence and the second synchronization sequence are OOK-4 waveform sequences, where a value of M of the OOK-4 waveform sequence of the first synchronization sequence is less than or equal to a value of M of the OOK-4 waveform sequence of the second synchronization sequence, and M represents a quantity of chips within one symbol.

For example, the value of M of the OOK-4 waveform sequence of the first synchronization sequence is greater than or equal to a preset threshold, and the value of M of the OOK-4 waveform sequence of the second synchronization sequence is less than or equal to the preset threshold. For example, the preset threshold may be 2 or another value.

In this embodiment, at least one of the first synchronization sequence or the second synchronization sequence is an OOK waveform sequence or an OOK-overlaid OFDM waveform sequence, so that power consumption and complexity in detecting the first synchronization sequence and the second synchronization sequence can be reduced. Similarly, defining the values of M of the first synchronization sequence and the second synchronization sequence differently can also reduce power consumption and complexity in detecting the first synchronization sequence and the second synchronization sequence.

In some embodiments, that the first device detects the first synchronization signal includes at least one of the following:
the first device detects the first synchronization sequence through energy detection; or
the first device detects at least one of the second synchronization sequence or the payload through sequence correlation detection.

For example, the sequence correlation detection may include coherent detection.

Coherent detection is a signal demodulation mechanism. Specifically, coherent detection refers to a detection method that multiplies a carrier of a modulation signal with a received modulated signal, and then obtains the modulation signal through low-pass filtering.

For example, the sequence correlation detection may be understood as sequence correlation or coherence detection, i.e., detection of correlation or coherence.

Correlation describes strength of a linear relationship between two variables in time domain.

Coherence describes a correlation between two signals in frequency domain, which is usually used in the field of signal processing.

For coherence, Fourier transform is mainly performed to convert a signal from time domain to frequency domain, and then a power spectrum density function thereof is calculated to determine coherence.

Coherence indicates consistency and a phase relationship between two signals in frequency.

In this embodiment, the first device may detect the first synchronization sequence through energy detection, that is, the first device does not need to buffer data for the first synchronization sequence, thereby reducing complexity and power consumption in detecting the first synchronization signal. The first device detects at least one of the second synchronization sequence or the payload through sequence correlation detection, which can ensure accuracy of a detection result of the at least one of the second synchronization sequence or the payload.

In some embodiments, that the first device detects the first synchronization signal may be implemented as follows:
the first device detects at least one of the second synchronization sequence or the payload in a case that the first synchronization sequence is detected; or
the first device detects the payload in a case that at least one of the first synchronization sequence or the second synchronization sequence is detected.

In this embodiment, the first device detects at least one of the second synchronization sequence or the payload in a case that the first synchronization sequence is detected, which can reduce complexity and power consumption in detecting at least one of the second synchronization sequence or the payload. The first device detects the payload in a case that at least one of the first synchronization sequence or the second synchronization sequence is detected, which can reduce complexity and power consumption in detecting the payload.

In some embodiments, that the first device detects the first synchronization signal may be implemented as follows:
the first device detects at least one of the second synchronization sequence or the payload based on first indication information.

The first indication information is used for indicating at least one of the following:
a demodulation parameter of at least one of the second synchronization sequence or the payload;
a time domain resource of at least one of the second synchronization sequence or the payload, where for example, the first indication information indicates a listening occasion of the second synchronization sequence;
a frequency domain resource of at least one of the second synchronization sequence or the payload;
a resource location of at least one of the second synchronization sequence or the payload relative to the first synchronization sequence, where for example, the resource location includes a monitoring occasion, or for example, the first indication information indicates an offset of the resource location of the second synchronization sequence relative to the first synchronization sequence; or
whether at least one of the second synchronization sequence or the payload exists after the first synchronization sequence.

For example, the resource location of at least one of the second synchronization sequence or the payload relative to the first synchronization sequence includes an offset of the resource location of the at least one of the second synchronization sequence or the payload relative to the first synchronization sequence. In other words, the first indication information may be used for indicating the offset of at least one of the second synchronization sequence or the payload. For example, the first indication information may be used for indicating an offset of at least one of the second synchronization sequence or the payload relative to the first synchronization sequence.

For example, the indication information indicates that the second synchronization sequence and the payload do not exist after the first synchronization sequence, which may be understood as that after the first synchronization sequence, another first synchronization sequence further needs to be detected, that is, other first synchronization sequences need to be detected. The indication information indicates that at least one of the second synchronization sequence or the payload exists after the first synchronization sequence, which may be understood as that the first device may detect at least one of the second synchronization sequence or the payload after the first synchronization sequence based on the indication information.

In this embodiment, since the first device detects at least one of the second synchronization sequence or the payload based on the first indication information, a location relationship among all portions can be configured more flexibly, and flexibility in detecting at least one of the second synchronization sequence or the payload can be improved.

In some embodiments, the first indication information is carried or indicated by at least one of the following:
the first synchronization sequence, protocol agreement information, or network configuration information.

For example, the protocol agreement information may also be referred to as pre-defined or pre-specified information.

For example, the network configuration information may be information configured by a network side device, for example, information configured by an access network device.

In some embodiments, the first device detects the payload based on second indication information.

The second indication information is used for indicating at least one of the following:
a demodulation parameter of the payload;
a time domain resource of the payload;
a frequency domain resource of the payload;
a time-frequency domain resource of the payload;
a resource location of the payload relative to at least one of the first synchronization sequence or the second synchronization sequence; or
whether the payload exists after the second synchronization sequence.

For example, the resource location of the payload relative to at least one of the first synchronization sequence or the seconde synchronization sequence includes an offset of the resource location of the payload relative to at least one of the first synchronization sequence or the second synchronization sequence. In other words, the second indication information may be used for indicating the offset of the payload. For example, the second indication information may may be used for indicating the offset of the resource location of the payload relative to at least one of the first synchronization sequence or the second synchronization sequence.

In this embodiment, since the first device detects the payload based on the second indication information, a location relationship among all portions can be configured more flexibly, and flexibility in detecting the payload can be improved.

In some embodiments, the second indication information is carried or indicated by at least one of the following:
the second synchronization sequence, protocol agreement information, or network configuration information.

For example, the protocol agreement information may also be referred to as pre-defined or pre-specified information.

For example, the network configuration information may be information configured by a network side device, for example, information configured by an access network device.

In some embodiments, the demodulation parameter of the payload is the same as the demodulation parameter of the second synchronization sequence. For example, in a case that the second synchronization sequence does not carry the second indication information or the second indication information does not include the demodulation parameter of the payload, the demodulation parameter of the payload is the same as the demodulation parameter of the second synchronization sequence. For another example, it may be specified by a protocol that the demodulation parameter of the payload is the same as the demodulation parameter of the second synchronization sequence.

The solutions of this application are described in detail below with reference to embodiments.

### Embodiment 1

In this embodiment, the first device includes an A-IoT communication device or a low power communication device.

FIG. 8 shows an example of a structure of a first synchronization signal according to an embodiment of this application.

As shown in FIG. 8, the first synchronization signal includes three portions, namely, a first synchronization sequence, a second synchronization sequence, and a payload portion.

In an example, as shown in FIG. 8, the first synchronization sequence adopts an OOK waveform with a low chip rate.

In an example, the first device may detect the first synchronization sequence through energy detection, that is, the first device does not need to buffer data or coherent demodulation for the first synchronization sequence, thereby reducing complexity and power consumption in detecting the first synchronization signal.

In an example, the first device may perform frequency domain synchronization by using the first synchronization sequence. For example, the first device slides in the frequency domain to identify a frequency range with a largest RSRP, so as to achieve coarse frequency domain synchronization by using the first synchronization sequence.

In an example, the first synchronization sequence may carry partial related configuration information of the second synchronization sequence and/or the payload portion, for example, an indication of a relative location relationship (for example, an offset of the second synchronization sequence), or for another example, a transmission period. In an example, to reduce a quantity of indication bits in the first synchronization sequence, a protocol-specified manner may be adopted, where a plurality of pieces of configuration information are jointly encoded, and then a corresponding sequence number is indicated in the first synchronization sequence.

To accommodate different A-IoT device types, the design of the first synchronization sequence may simultaneously support synchronization for type A, type B, and type C devices.

After successfully detecting the first synchronization sequence, the first device may obtain coarse downlink synchronization, for example, obtain synchronization at a granularity of slot. Then, the first device detects the second synchronization sequence at a corresponding time-frequency domain location to obtain a higher downlink synchronization precision.

A difference is designed between the chip rates of the second synchronization sequence and the first synchronization sequence is to improve a communication rate. For example, the chip rate of the second synchronization sequence is higher than that of the first synchronization sequence. Furthermore, since coarse synchronization has been obtained, the first device can buffer data within a small range around the second synchronization sequence and then detect the second synchronization sequence through coherent demodulation. In this way, not only a data buffer range can be reduced, for example, from a buffer length of 20 ms in NR to a buffer length of approximately one slot, but also reliability of sequence detection can be ensured.

A precise synchronization process is as follows: The first device may obtain accurate downlink synchronization, for example, downlink synchronization at a granularity of a chip or an OFDM symbol.

In an example, the second synchronization sequence carries partial related configuration information of the payload portion, for example, demodulation information, such as a chip rate of the payload portion or a value of M; or resource information, such as time-frequency domain location information or transmission period information. Certainly, to reduce a quantity of indication bits in the second synchronization sequence, a protocol-specified manner may be adopted, where a plurality of pieces of configuration information are jointly encoded, and then a corresponding sequence number is indicated in the second synchronization sequence. In another case, if the second synchronization sequence does not carry related indication information (for example, a period or a chip rate) of the payload portion, the first device may determine that the second synchronization sequence and the payload portion use the same configuration parameter. Alternatively, it may be specified by a protocol that the second synchronization sequence and the payload portion use some same parameters, for example, a same chip rate.

In an example, the second synchronization sequence carries partial bit information of a cell ID (for example, a least significant bit (Least Significant Bit)). Further, after completing the two synchronization sequence detection operations, the first device may further detect the payload portion at the corresponding time-frequency domain location. The payload portion carries critical cell-level broadcast information, such as a cell ID, partial cell ID information, or MIB information.

It should be noted that, FIG. 8 is merely an example of this application, and should not be construed as a limitation on this application.

For example, in another alternative embodiment, at least one of an interval 1 or an interval 2 in FIG. 8 may be 0, meaning that any two of the three portions may be concatenated end-to-end. Alternatively, both the interval 1 and the interval 2 may be non-zero, meaning that no two portions are concatenated end-to-end.

### Embodiment 2

In this embodiment, to reduce a network load, achieve more flexible configuration, and accommodate tolerance of low power terminal for transmission delays, the three portions of a low power synchronization signal may be separated.

Specifically, the separation may be achieved from two perspectives as follows:
1) different transmission periods for different portions; and
2) discontinuous time domain locations for different portions.

For 1):

In an example, the transmission period of the first synchronization sequence may be different from the transmission periods of the second synchronization sequence and the payload portion. For example, the transmission period of the first synchronization sequence is N times the transmission periods of the second synchronization sequence and the payload portion, where N may be ¼, ½, 1, 2, 4, or the like. In a case, the period of the first synchronization sequence is small, and the period of the second synchronization signal is large. Within one period, the second synchronization signal may occupy more resources than the first synchronization signal, allowing a single detection operation to meet requirements in performance.

In another example, time domain offsets of different portions are different and are relative to the same starting time. In other words, despite having different periods, all portions, when present within one period, may be arranged with no intervals, that is, continuously.

It should be noted that at least one of the first synchronization sequence, the second synchronization sequence, or the payload may be repeatedly transmitted.

FIG. 9 shows an example of a first synchronization signal according to an embodiment of this application.

As shown in FIG. 9, in a case (case 1), the first synchronization sequence, for example, 1^{st} and 3^{rd} first synchronization sequences shown in the figure, is immediately followed by a second synchronization sequence and a payload portion. In another case (case 2), the first synchronization sequence, for example, 2^{nd} and 4^{th} first synchronization sequences shown in the figure, is followed by no second synchronization sequence and no payload portion.

In an example, blind detection is performed to determine whether at least one of the second synchronization sequence or the payload portion exists. The first device may perform blind (blind) detection in the foregoing case. For example, the first device may attempt to detect the second synchronization sequence after the first synchronization sequence. If no second synchronization sequence is detected, it is determined that no second synchronization sequence follows the first synchronization sequence. That is, a repeatedly transmitted first synchronization sequence exists. The first device then attempts to detect the first synchronization sequence and the second synchronization sequence at a next first synchronization sequence location. In other words, it may be determined that the first synchronization sequence does not carry an indication indicating whether at least one of the second synchronization sequence or the payload portion exists.

In another example, the first device may determine, based on the first synchronization sequence, whether at least one of the second synchronization sequence or the payload portion exists. For example, the first device may respectively associate different first synchronization sequences with presence or absence of at least one of the second synchronization sequence or the payload portion. That is, in the foregoing two cases, different first synchronization sequences are used. For example, in case 1, a first synchronization sequence 1 is used, and in case 2, a first synchronization sequence 2 is used. The first device may determine, depending whether the detected first synchronization sequence is the sequence 1 or the sequence 2, whether a second synchronization sequence and/or a payload portion follows.

For example, a network side configures or a protocol specifies at least two first synchronization sequences, where different first synchronization sequences are associated with resource locations or resource patterns, including a period and/or an offset, of different second synchronization sequences and/or payload portions. For example, an interval between second synchronization sequences associated with the first synchronization sequence 1 is 0, an interval between second synchronization sequences associated with the first synchronization sequence 2 is 1 ms, and an interval between second synchronization sequences associated with the first synchronization sequence 3 is 2 ms.

An advantage of 1) is achieving more flexible configuration of periods of all portions based on different requirements.

For 2):

In an example, a relative location relationship among different portions is that their time domain locations are discontinuous.

For example, the offset of the second synchronization sequence and/or the offset of the payload portion is determined relative to the first synchronization sequence. Further, the offset of the payload portion is determined relative to the second synchronization sequence. For example, the offset of the second synchronization sequence relative to the payload portion is a length of the payload portion. Specifically, a relative location relationship among different portions may be configured by a network side device or specified by a protocol, or may be carried or indicated by each portion. For example, the first synchronization sequence indicates the offset of the second synchronization sequence and/or the payload portion. For another example, the second synchronization sequence indicates the offset of the payload portion.

FIG. 10 shows an example of a first synchronization signal according to an embodiment of this application.

As shown in FIG. 10, a plurality of occasions (occasion) may exist within a period of a first synchronization sequence. Further, repeated transmission of a second synchronization sequence and a payload may be performed on the plurality of occasions.

An advantage of 2) is achieving more flexible configuration of a location relationship among all portions.

The synchronization signal transmission method provided in embodiments of this application may be performed by a synchronization signal transmission apparatus. In embodiments of this application, the synchronization signal transmission apparatus provided in embodiments of this application is described by using an example in which the synchronization signal transmission apparatus performs the synchronization signal transmission method.

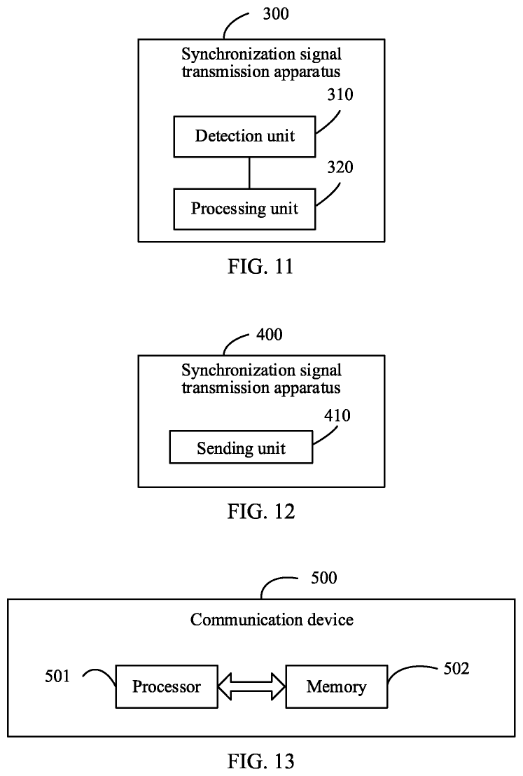

FIG. 11 is a schematic block diagram of a synchronization signal transmission apparatus 300 according to an embodiment of this application.

As shown in FIG. 11, the synchronization signal transmission apparatus 300 includes a detection unit 310 and a processing unit 320.

The detection unit 310 is configured to detect a first synchronization signal.

The first synchronization signal includes a first synchronization sequence, a second synchronization sequence, and a payload.

The processing unit 320 is configured to perform at least one of time-frequency domain synchronization, cell search, cell selection, channel measurement, or cell broadcast based on the first synchronization signal.

In some embodiments, the first synchronization signal satisfies at least one of the following:
transmission periods or update periods of at least two of the first synchronization sequence, the second synchronization sequence, and the payload are different;
the transmission periods or update periods of at least two of the first synchronization sequence, the second synchronization sequence, and the payload satisfy a multiple relationship;
offset values of at least two of the first synchronization sequence, the second synchronization sequence, and the payload are different;
reference locations of the offset value of the first synchronization sequence, the offset value of the second synchronization sequence, and the offset value of the payload are the same;
at least one of the offset value of the second synchronization sequence or the offset value of the payload is determined based on the first synchronization sequence;
at least two of the first synchronization sequence, the second synchronization sequence, and the payload have or do not have a transmission interval;
a chip rate of the first synchronization sequence is different from a chip rate of the second synchronization sequence;
a synchronization precision of the first synchronization sequence is less than a synchronization precision of the second synchronization sequence;
a transmission resource quantity of the first synchronization sequence is different from at least one of a transmission resource quantity of the second synchronization sequence or a transmission resource quantity of the payload;
a waveform of the first synchronization sequence is different from a waveform of the second synchronization sequence;
a receiver for receiving the first synchronization sequence is different from a receiver for receiving the second synchronization sequence; or
at least one of the first synchronization sequence or the second synchronization sequence is a low power synchronization sequence.

In some embodiments, the processing unit 320 is further configured to:
perform, based on the first synchronization sequence, at least one of frequency domain synchronization at a first precision or time synchronization at a second precision, where the first precision is at a granularity selected from at least one of a resource block RB, a resource element RE, an RB set, a synchronization raster, or a synchronization raster set, and the second precision is at a granularity selected from at least one of a system frame, a half-frame, a subframe, a slot, or a symbol.

In some embodiments, the first synchronization sequence includes at least one of the following characteristics:
the first synchronization sequence is a synchronization sequence applicable to at least one device type, where the at least one device type includes at least one of a type A, a type B, or a type C; or
in the first synchronization sequence, a duty cycle of a first level is greater than or equal to a duty cycle of a second level.

In some embodiments, the processing unit 320 is further configured to: perform, based on the second synchronization sequence, at least one of frequency domain synchronization at a third precision or time synchronization at a fourth precision, where the third precision is at a granularity selected from at least one of an RB, an RE, or a synchronization raster, and the fourth precision is at a granularity selected from at least one of a symbol or a chip.

In some embodiments, the second synchronization sequence carries partial information of cell identity information, and the payload carries information in the cell identity information other than the partial information of the cell identity information carried in the second synchronization sequence; or the payload carries the cell identity information; or the first synchronization sequence does not carry the cell identity information; or the first synchronization signal carries the cell identity information.

In some embodiments, the payload carries at least one of the following information: a main information block MIB, remaining system information RMSI, a system frame number SFN, or a half-frame indicator.

In some embodiments, the payload satisfies at least one of the following:
the payload follows the first synchronization sequence;
the payload follows the second synchronization sequence; or
the payload includes a first portion and a second first portion, where the first portion follows the first synchronization sequence, and the second first portion follows the second synchronization sequence.

In some embodiments, at least one of the first synchronization sequence or the second synchronization sequence is an OOK waveform sequence or an OOK-overlaid OFDM waveform sequence.

In some embodiments, the first synchronization sequence is an OOK-1 waveform sequence, and the second synchronization sequence is an OOK-4 waveform sequence; or
the first synchronization sequence and the second synchronization sequence are OOK-4 waveform sequences, where a value of M of the OOK-4 waveform sequence of the first synchronization sequence is less than or equal to a value of M of the OOK-4 waveform sequence of the second synchronization sequence, and M represents a quantity of chips within one symbol.

In some embodiments, the detection unit 310 is specifically configured to:
detect the first synchronization sequence through energy detection; and
detect at least one of the second synchronization sequence or the payload through sequence correlation detection.

In some embodiments, the detection unit 310 is specifically configured to:
detect at least one of the second synchronization sequence or the payload in a case that the first synchronization sequence is detected; or
detect the payload in a case that at least one of the first synchronization sequence or the second synchronization sequence is detected.

In some embodiments, the detection unit 310 is specifically configured to:
detect at least one of the second synchronization sequence or the payload based on first indication information.

The first indication information is used for indicating at least one of the following:
a demodulation parameter of at least one of the second synchronization sequence or the payload;
a time domain resource of at least one of the second synchronization sequence or the payload,
a frequency domain resource of at least one of the second synchronization sequence or the payload;
a resource location of at least one of the second synchronization sequence or the payload relative to the first synchronization sequence; or
whether at least one of the second synchronization sequence or the payload exists after the first synchronization sequence.

In some embodiments, the first indication information is carried or indicated by at least one of the following:
the first synchronization sequence, protocol agreement information, or network configuration information.

It should be understood that the synchronization signal transmission apparatus 300 provided in this embodiment of this application may correspond to the first device in the method embodiments of this application, and the foregoing (or other) operations or functions of the units in the synchronization signal transmission apparatus 300 are separately intended to implement corresponding processes in the method embodiments shown in FIG. 6 performed by the first device. To avoid repetition, details are not described herein.

FIG. 12 is a schematic block diagram of a synchronization signal transmission apparatus 400 according to an embodiment of this application.

As shown in FIG. 12, the synchronization signal transmission apparatus 400 includes:
a sending unit 410, configured to send a first synchronization signal to a first device.

The first synchronization signal includes a first synchronization sequence, a second synchronization sequence, and a payload, where the first synchronization signal is used for at least one of time-frequency domain synchronization, cell search, cell selection, channel measurement, or cell broadcast.

In some embodiments, the first synchronization signal satisfies at least one of the following:
transmission periods or update periods of at least two of the first synchronization sequence, the second synchronization sequence, or the payload are different;
the transmission periods or update periods of at least two of the first synchronization sequence, the second synchronization sequence, or the payload satisfy a multiple relationship;
offset values of at least two of the first synchronization sequence, the second synchronization sequence, and the payload are different;
reference locations of the offset value of the first synchronization sequence, the offset value of the second synchronization sequence, and the offset value of the payload are the same;
at least one of the offset value of the second synchronization sequence or the offset value of the payload is determined based on the first synchronization sequence;
at least two of the first synchronization sequence, the second synchronization sequence, and the payload have or do not have a transmission interval;
a chip rate of the first synchronization sequence is different from a chip rate of the second synchronization sequence;
a synchronization precision of the first synchronization sequence is less than a synchronization precision of the second synchronization sequence;
a transmission resource quantity of the first synchronization sequence is different from at least one of a transmission resource quantity of the second synchronization sequence or a transmission resource quantity of the payload;
a waveform of the first synchronization sequence is different from a waveform of the second synchronization sequence;
a receiver for receiving the first synchronization sequence is different from a receiver for receiving the second synchronization sequence; or
at least one of the first synchronization sequence or the second synchronization sequence is a low power synchronization sequence.

In some embodiments, the first synchronization sequence includes at least one of the following characteristics:
the first synchronization sequence is a synchronization sequence applicable to at least one device type, where the at least one device type includes at least one of a type A, a type B, or a type C; or
in the first synchronization sequence, a duty cycle of a first level is greater than or equal to a duty cycle of a second level.

In some embodiments, the second synchronization sequence carries partial information of cell identity information, and the payload carries information in the cell identity information other than the partial information of the cell identity information carried in the second synchronization sequence; or the payload carries the cell identity information; or the first synchronization sequence does not carry the cell identity information; or the first synchronization signal carries the cell identity information.

In some embodiments, the payload includes at least one of the following: a main information block MIB, remaining system information RMSI, a system frame number SFN, or a half-frame indicator.

In some embodiments, the payload satisfies at least one of the following:
the payload follows the first synchronization sequence;
the payload follows the second synchronization sequence; or
the payload includes a first portion and a second first portion, where the first portion follows the first synchronization sequence, and the second first portion follows the second synchronization sequence.

In some embodiments, at least one of the first synchronization sequence or the second synchronization sequence is an OOK waveform sequence or an OOK-overlaid OFDM waveform sequence.

In some embodiments, the first synchronization sequence is an OOK-1 waveform sequence, and the second synchronization sequence is an OOK-4 waveform sequence; or
the first synchronization sequence and the second synchronization sequence are OOK-4 waveform sequences, where a value of M of the OOK-4 waveform sequence of the first synchronization sequence is less than or equal to a value of M of the OOK-4 waveform sequence of the second synchronization sequence, and M represents a quantity of chips within one symbol.

In some embodiments, the first synchronization signal carries first indication information, where the first indication information is used for indicating at least one of the following:
a demodulation parameter of at least one of the second synchronization sequence or the payload;
a time domain resource of at least one of the second synchronization sequence or the payload;
a frequency domain resource of at least one of the second synchronization sequence or the payload;
a resource location of at least one of the second synchronization sequence or the payload relative to the first synchronization sequence; or
whether at least one of the second synchronization sequence or the payload exists after the first synchronization sequence.

It should be understood that the synchronization signal transmission apparatus 400 provided in this embodiment of this application may correspond to the second device in the method embodiments of this application, and the foregoing (or other) operations or functions of the units in the synchronization signal transmission apparatus 400 are separately intended to implement corresponding processes in the method embodiments shown in FIG. 6 performed by the second device. To avoid repetition, details are not described herein.

The synchronization signal transmission apparatus in embodiments of this application may be an electronic device, for example, an electronic device having an operating system, or may be a component in the electronic device, for example, an integrated circuit or a chip. The electronic device may be the first device, the second device, or devices other than the terminal. The first device may be a terminal, and the second device may be a network side device or a terminal. For example, the terminal may include but is not limited to the foregoing listed types of the terminal 11, the network side device may include but is not limited to the foregoing listed types of the network side device 12, and the other devices may be a server, a network attached storage (Network Attached Storage, NAS), or the like. This is not specifically limited in this embodiment of this application.

The synchronization signal transmission apparatus provided in embodiments of this application can implement each process in the method embodiment of FIG. 6, and achieve the same technical effects. To avoid repetition, details are not described herein again.

FIG. 13 shows an example of a communication device 500 according to an embodiment of this application.

As shown in FIG. 13, the communication device 500 includes a processor 501 and a memory 502. The memory 502 stores a program and an instruction runnable on the processor 501. The program or the instruction, when executed by the processor 501, implements the steps in the embodiment of the foregoing synchronization signal transmission method. For example, when the communication device 500 is a first device, the program or the instruction, when executed by the processor 501, implements the steps in the embodiment of the foregoing synchronization signal transmission method performed by the first device, and can achieve the same technical effects. When the communication device 500 is a second device, the program or the instruction, when executed by the processor 501, implements the steps in the embodiment of the foregoing synchronization signal transmission method performed by the second device, and can achieve the same technical effect. To avoid repetition, details are not described herein.

An embodiment of this application further provides a first device, including a processor and a communication interface. The communication interface is coupled to the processor, and the processor is configured to run a program or an instruction, to implement the steps in the method embodiment shown in FIG. 6. The embodiment of the first device corresponds to the method embodiment of the first device. The implementation processes and manners of the method embodiment are applicable to the embodiment of the first device, and can achieve the same technical effects.

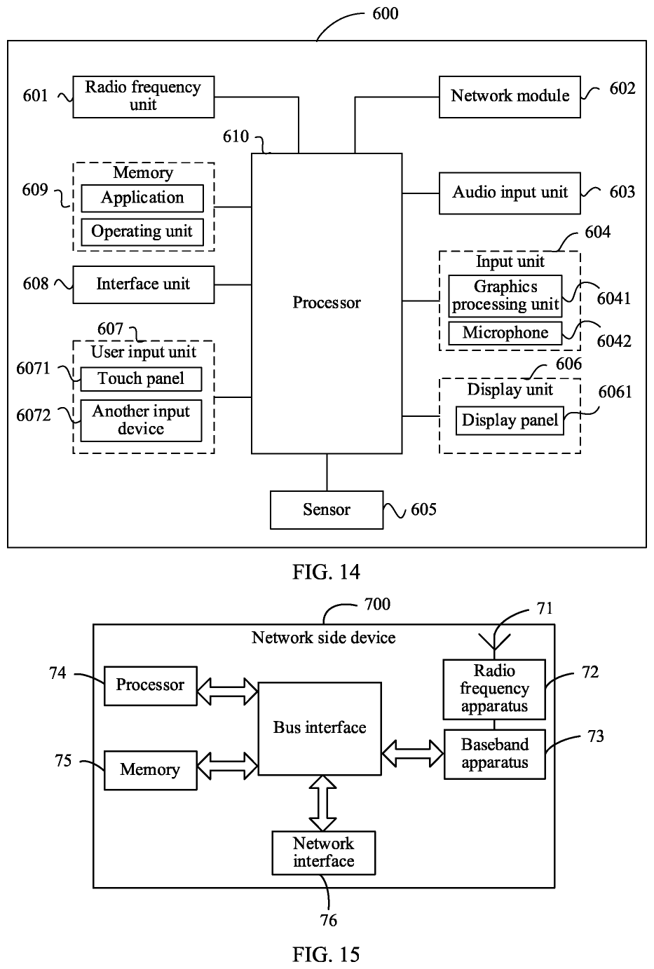

FIG. 14 is a schematic diagram of a hardware structure of a terminal for implementing an embodiment of this application.

As shown in FIG. 14, a terminal 600 includes, but is not limited to, at least part of the following components: a radio frequency unit 601, a network module 602, an audio output unit 603, an input unit 604, a sensor 605, a display unit 606, a user input unit 607, an interface unit 606, a memory 609, and a processor 610.

A person skilled in the art may understand that the terminal 600 may further include a power supply (for example, a battery) that supplies power to the components. The power supply may be logically connected to the processor 610 through a power management system, thereby implementing functions such as management of charging, discharging, and power consumption through the power management system. The terminal structure shown in FIG. 14 constitutes no limitation on the terminal, and the terminal may include more or fewer components than those shown in the figure, or some merged components, or different component arrangements. Details are not described herein.

It should be understood that, in this embodiment of this application, the input unit 604 may include a graphics processing unit (Graphics Processing Unit, GPU) 6041 and a microphone 6042. The graphics processing unit 6041 processes picture data of a static picture or a video obtained by a picture capturing apparatus (for example, a camera) in a video capturing mode or a picture capturing mode. The display unit 606 may include a display panel 6061. The display panel 6061 may be configured in a form such as a liquid crystal display or an organic light-emitting diode. The user input unit 607 includes at least one of a touch panel 6071 and another input device 6072. The touch panel 6071 is also referred to as a touch screen. The touch panel 6071 may include two parts, that is, a touch detection apparatus and a touch controller. The another input device 6072 may include but is not limited to a physical keyboard, a function key (such as a volume control key and a switch key), a trackball, a mouse, and a joystick.

In this embodiment of this application, the radio frequency unit 601 receives downlink data from a network side device, and then may transmit the data to the processor 610 for processing. In addition, the radio frequency unit 601 may send uplink data to the network side device. Generally, the radio frequency unit 601 includes but is not limited to an antenna, an amplifier, a transceiver, a coupler, a low noise amplifier, a duplexer, and the like.

The memory 609 may be configured to store a software program or an instruction and various data. The memory 609 may mainly include a first storage area for storing programs or instructions and a second storage area for storing data. The first storage area may store an operating system, an application or an instruction required for at least one function (such as a sound playback function and a picture playback function), and the like. In addition, the memory 609 may include a volatile memory or a nonvolatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct rambus random access memory (Direct Rambus RAM, DRRAM). The memory 609 in this embodiment of this application includes but is not limited to these and any other suitable types of memories.

The processor 610 may include one or at least two processing units. Optionally, the processor 610 integrates an application processor and a modem processor. The application processor mainly processes operations related to an operating system, a user interface, an application, or the like. The modem processor, for example, a baseband processor, mainly processes wireless communication signals. It may be understood that the modem processor may alternatively not be integrated in the processor 610.

The radio frequency unit 601 is configured to detect a first synchronization signal.

The first synchronization signal includes a first synchronization sequence, a second synchronization sequence, and a payload.

The processor 610 is configured to perform at least one of time-frequency domain synchronization, cell search, cell selection, channel measurement, or cell broadcast based on the first synchronization signal.

In this embodiment, since a synchronization sequence can carry only limited information, designing the first synchronization signal to include the first synchronization sequence and the second synchronization sequence can reduce an amount of information the first device needs to buffer. In other words, the terminal does not need to buffer a payload with a large amount of information, thereby reducing power consumption and complexity in synchronization signal detection. This is particularly suitable for A-IoT communication devices.

It may be understood that, for implementation processes of various implementations mentioned in this embodiment, refer to related descriptions in the method embodiments, and the same or corresponding technical effects are achieved. To avoid repetition, details are not described herein.

An embodiment of this application further provides a second device, including a processor and a communication interface. The communication interface is coupled to the processor, and the processor is configured to run a program or an instruction, to implement the steps in the method embodiment shown in FIG. 6. The embodiment of the second device corresponds to the method embodiment of the second device. The implementation processes and manners of the method embodiment are applicable to the embodiment of the second device, and can achieve the same technical effects.

FIG. 15 shows an example of a network side device 700 according to an embodiment of this application.

As shown in FIG. 15, the network side device 700 includes an antenna 71, a radio frequency apparatus 72, a baseband apparatus 73, a processor 74, and a memory 75. The antenna 71 is connected to the radio frequency apparatus 72. In an uplink direction, the radio frequency apparatus 72 receives information through the antenna 71, and sends the received information to the baseband apparatus 73 for processing. In a downlink direction, the baseband apparatus 73 processes to-be-sent information, and sends the processed to-be-sent information to the radio frequency apparatus 72. The radio frequency apparatus 72 processes the received information, and then sends the processed information through the antenna 71.

The method performed by the network side device in the foregoing embodiments may be implemented by the baseband apparatus 73. The baseband apparatus 73 includes a baseband processor.

The baseband apparatus 73 may include, for example, at least one baseband board. Two chips are arranged on the baseband board. As shown in FIG. 15, a chip is, for example, a baseband processor, and is connected to the memory 75 through a bus interface to invoke a program in the memory 75 to perform the corresponding process of the network side device in the foregoing method embodiments.

The network side device may further include a network interface 76. The interface, for example, is a common public radio interface (Common Public Radio Interface, CPRI).

Specifically, the network side device 700 in this embodiment of this application further includes an instruction or a program stored in the memory 75 and runnable on the processor 74. The processor 74 invokes the instruction or the program in the memory 75 to perform the steps performed by the units in the synchronization signal transmission apparatus shown in FIG. 12, and achieves the same technical effects. To avoid repetition, details are not described herein.

An embodiment of this application further provides a readable storage medium. The readable storage medium stores a program or an instruction. The program or the instruction, when executed by a processor, implements the processes of the embodiment of the foregoing synchronization signal transmission method, and can achieve the same technical effects. To avoid repetition, details are not described herein.

The processor is a processor in the terminal in the foregoing embodiments. The readable storage medium includes a computer-readable storage medium, for example, a computer read-only memory ROM, a random access memory RAM, a floppy disk, or an optical disk. In some examples, the readable storage medium may be a non-transient readable storage medium.

An embodiment of this application further provides a chip. The chip includes a processor and a communication interface. The communication interface is coupled to the processor. The processor is configured to run a program or an instruction, to implement the processes of the embodiment of the foregoing synchronization signal transmission method, and can achieve the same technical effects. To avoid repetition, details are not described herein.

It should be understood that the chip mentioned in this embodiment of this application may also be referred to as a system level chip, a system chip, a chip system, a system on chip, or the like.

An embodiment of this application further provides a computer program/program product. The computer program/program product is stored in a storage medium. The computer program/program product is executed by at least one processor to implement the processes of the embodiment of the foregoing synchronization signal transmission method, and can achieve the same technical effects. To avoid repetition, details are not described herein.

An embodiment of this application further provides a communication system, including a first device and a second device. The first device may be configured to perform the steps in the above-described synchronization signal transmission method performed by the first device, and the second device may be configured to perform the steps in the above-described synchronization signal transmission method performed by the second device.

It should be noted that, the term “include”, “comprise”, or any other variant thereof herein is intended to encompass non-exclusive inclusion, so that a process, a method, an article, or an apparatus including a series of elements not only includes those elements, but also includes another element not listed explicitly, or includes intrinsic elements for the process, the method, the article, or the apparatus. Without any further limitation, an element defined by the phrase “include one . . . ” does not exclude existence of an additional same element in the process, the method, the article, or the apparatus that includes the element. In addition, it should be noted that the scope of the method and the apparatus in the implementations of this application is not limited to function execution in the order shown or discussed, and may further include function execution in a substantially simultaneous manner or in a reverse order based on the involved functions. For example, the described method may be performed in an order different from the described order, and various steps may be added, omitted, or combined. In addition, features described in combination with some examples may be combined in another example.

According to the descriptions of the foregoing implementations, a person skilled in the art may clearly understand that the foregoing method embodiments may be implemented by using a computer software product and a necessary universal hardware platform, or may certainly be implemented by using hardware. The computer software product is stored in a storage medium (for example, a ROM, a RAM, a magnetic disk, or an optical disk), and includes instructions, to enable a terminal or a network side device to perform the methods described in embodiments of this application.

Although embodiments of this application are described above with reference to the drawings, this application is not limited to the foregoing specific implementations. The foregoing specific implementations are illustrative only but not restrictive. With the enlightenment of this application, a person of ordinary skill in the art may make implementations of many forms without departing from the concept of this application and the protection scope of the claims. These implementations fall within the protection of this application.

What is claimed is:

1. A synchronization signal transmission method, comprising:
detecting, by a first device, a first synchronization signal, wherein
the first synchronization signal comprises a first synchronization sequence, a second synchronization sequence, and a payload, wherein at least one of the first synchronization sequence or the second synchronization sequence is an OOK waveform sequence; and
performing, by the first device, at least one of time-frequency domain synchronization, cell search, cell selection, channel measurement, or cell broadcast based on the first synchronization signal.

2. The method according to claim 1, wherein the first synchronization signal satisfies at least one of the following:
transmission periods or update periods of at least two of the first synchronization sequence, the second synchronization sequence, and the payload are different;
a waveform of the first synchronization sequence is different from a waveform of the second synchronization sequence;
the transmission periods or update periods of at least two of the first synchronization sequence, the second synchronization sequence, and the payload satisfy a multiple relationship;
offset values of at least two of the first synchronization sequence, the second synchronization sequence, and the payload are different;
reference locations of the offset value of the first synchronization sequence, the offset value of the second synchronization sequence, and the offset value of the payload are the same;
at least one of the offset value of the second synchronization sequence or the offset value of the payload is determined based on the first synchronization sequence;
at least two of the first synchronization sequence, the second synchronization sequence, and the payload have or do not have a transmission interval;
a chip rate of the first synchronization sequence is different from a chip rate of the second synchronization sequence;
a synchronization precision of the first synchronization sequence is less than a synchronization precision of the second synchronization sequence;
a transmission resource quantity of the first synchronization sequence is different from at least one of a transmission resource quantity of the second synchronization sequence and a transmission resource quantity of the payload;
a receiver for receiving the first synchronization sequence is different from a receiver for receiving the second synchronization sequence; or
at least one of the first synchronization sequence or the second synchronization sequence is a low power synchronization sequence.

3. The method according to claim 1, further comprising:
performing, by the first device based on the first synchronization sequence, at least one of frequency domain synchronization at a first precision or time synchronization at a second precision, wherein the first precision is at a granularity selected from at least one of a resource block RB, a resource element RE, an RB set, a synchronization raster, or a synchronization raster set, and the second precision is at a granularity selected from at least one of a system frame, a half-frame, a subframe, a slot, or a symbol.

4. The method according to claim 1, wherein the first synchronization sequence comprises at least one of the following characteristics:
the first synchronization sequence is a synchronization sequence applicable to at least one device type, wherein the at least one device type comprises at least one of a type A, a type B, or a type C; and
in the first synchronization sequence, a duty cycle of a first level is greater than or equal to a duty cycle of a second level.

5. The method according to claim 1, further comprising:
performing, by the first device based on the second synchronization sequence, at least one of frequency domain synchronization at a third precision or time synchronization at a fourth precision, wherein the third precision is at a granularity selected from at least one of an RB, an RE, or a synchronization raster, and the fourth precision is at a granularity selected from at least one of a symbol or a chip.

6. The method according to claim 1, wherein the second synchronization sequence carries partial information of cell identity information, and the payload carries information in the cell identity information other than the partial information of the cell identity information carried in the second synchronization sequence; or the payload carries the cell identity information; or the first synchronization sequence does not carry the cell identity information; or the first synchronization signal carries the cell identity information.

7. The method according to claim 1, wherein the payload carries at least one of the following information:
a main information block (MIB), remaining system information (RMSI), a system frame number (SFN), or a half-frame indicator.

8. The method according to claim 1, wherein the payload satisfies at least one of the following:
the payload follows the first synchronization sequence;
the payload follows the second synchronization sequence; or
the payload comprises a first portion and a second first portion, wherein the first portion follows the first synchronization sequence, and the second first portion follows the second synchronization sequence.

9. The method according to claim 1, wherein the first synchronization sequence is an OOK-1 waveform sequence, and the second synchronization sequence is an OOK-4 waveform sequence; or
the first synchronization sequence and the second synchronization sequence are OOK-4 waveform sequences, wherein a value of M of the OOK-4 waveform sequence of the first synchronization sequence is less than or equal to a value of M of the OOK-4 waveform sequence of the second synchronization sequence, and M represents a quantity of chips within one symbol.

10. The method according to claim 1, wherein the detecting, by a first device, a first synchronization signal comprises at least one of the following:
detecting, by the first device, the first synchronization sequence through energy detection; and
detecting, by the first device, at least one of the second synchronization sequence or the payload through sequence correlation detection.

11. The method according to claim 1, wherein the detecting, by a first device, a first synchronization signal comprises:
detecting, by the first device, at least one of the second synchronization sequence or the payload in a case that the first synchronization sequence is detected; or
detecting, by the first device, the payload in a case that at least one of the first synchronization sequence or the second synchronization sequence is detected.

12. The method according to claim 1, wherein the detecting, by a first device, a first synchronization signal comprises:
detecting, by the first device, at least one of the second synchronization sequence or the payload based on first indication information, wherein
the first indication information is used for indicating at least one of the following:
a demodulation parameter of at least one of the second synchronization sequence or the payload;
a time domain resource of at least one of the second synchronization sequence or the payload;
a frequency domain resource of at least one of the second synchronization sequence or the p ayload;
a resource location of at least one of the second synchronization sequence or the payload relative to the first synchronization sequence; or
whether at least one of the second synchronization sequence or the payload exists after the first synchronization sequence.

13. A synchronization signal transmission method, comprising:
sending, by a second device, a first synchronization signal to a first device, wherein
the first synchronization signal comprises a first synchronization sequence, a second synchronization sequence, and a payload, wherein at least one of the first synchronization sequence or the second synchronization sequence is an OOK waveform sequence, and the first synchronization signal is used for at least one of time-frequency domain synchronization, cell search, cell selection, channel measurement, or cell broadcast.

14. The method according to claim 13, wherein the first synchronization signal satisfies at least one of the following:
transmission periods or update periods of at least two of the first synchronization sequence, the second synchronization sequence, and the payload are different;
a waveform of the first synchronization sequence is different from a waveform of the second synchronization sequence;
the transmission periods or update periods of at least two of the first synchronization sequence, the second synchronization sequence, and the payload satisfy a multiple relationship;
offset values of at least two of the first synchronization sequence, the second synchronization sequence, and the payload are different;
reference locations of the offset value of the first synchronization sequence, the offset value of the second synchronization sequence, and the offset value of the payload are the same;
at least one of the offset value of the second synchronization sequence and the offset value of the payload is determined based on the first synchronization sequence;
at least two of the first synchronization sequence, the second synchronization sequence, and the payload have or do not have a transmission interval;
a chip rate of the first synchronization sequence is different from a chip rate of the second synchronization sequence;
a synchronization precision of the first synchronization sequence is less than a synchronization precision of the second synchronization sequence;
a transmission resource quantity of the first synchronization sequence is different from at least one of a transmission resource quantity of the second synchronization sequence and a transmission resource quantity of the payload;
a receiver for receiving the first synchronization sequence is different from a receiver for receiving the second synchronization sequence; or
at least one of the first synchronization sequence and the second synchronization sequence is a low power synchronization sequence.

15. The method according to claim 13, the first synchronization sequence comprises at least one of the following characteristics:
the first synchronization sequence is a synchronization sequence applicable to at least one device type, wherein the at least one device type comprises at least one of a type A, a type B, or a type C; or
in the first synchronization sequence, a duty cycle of a first level is greater than or equal to a duty cycle of a second level.

16. The method according to claim 13, wherein the second synchronization sequence carries partial information of cell identity information, and the payload carries information in the cell identity information other than the partial information of the cell identity information carried in the second synchronization sequence; or the payload carries the cell identity information; or the first synchronization sequence does not carry the cell identity information;
or the first synchronization signal carries the cell identity information.

17. The method according to claim 13, wherein the payload comprises at least one of the following:
a main information block (MIB), remaining system information (RMSI), a system frame number (SFN), and a half-frame indicator.

18. The method according to claim 13, wherein the payload satisfies at least one of the following:
the payload follows the first synchronization sequence;
the payload follows the second synchronization sequence; or
the payload comprises a first portion and a second first portion, wherein the first portion follows the first synchronization sequence, and the second first portion follows the second synchronization sequence.

19. A first device, comprising a transceiver, a processor, and a memory, wherein the memory stores a program or an instruction runnable on the processor, and the program or the instruction, when executed by the processor, implements following steps:
detecting a first synchronization signal, wherein
the first synchronization signal comprises a first synchronization sequence, a second synchronization sequence, and a payload, wherein at least one of the first synchronization sequence or the second synchronization sequence is an OOK waveform sequence; and
performing at least one of time-frequency domain synchronization, cell search, cell selection, channel measurement, or cell broadcast based on the first synchronization signal.

20. A second device, comprising a transceiver, a processor, and a memory, wherein the memory stores a program or an instruction runnable on the processor, and the program or the instruction, when executed by the processor, implements the synchronization signal transmission method according to claim 13.
